(19) United States
(12) Patent Application Publication
(10) Pub. No.: US 2019/0103746 A1
(43) Pub. Date: Apr. 4, 2019

(54) RESERVOIR COMBINER SYSTEM

(71) Applicant: General Electric Company, Schenectady, NY (US)

(72) Inventors: Luca Tonini, Glenville, NY (US); Kenneth McClellan Rush, Ballston Spa, NY (US)

(73) Assignee: General Electric Company, Schenectady, NY (US)

(21) Appl. No.: 16/018,376

(22) Filed: Jun. 26, 2018

Related U.S. Application Data
(60) Provisional application No. 62/566,413, filed on Sep. 30, 2017.

(51) Int. Cl. H02J 3/32; H02J 3/38; H02S 40/38; H02S 40/32; H02S 40/36

(52) U.S. Cl. CPC H02J 3/32; H02J 3/383; H02J 3/386; H02S 50/00; H02S 40/32; H02S 40/36; H02S 40/38

(57) ABSTRACT

A reservoir includes power generation sources and energy storage systems. Some of the energy storage systems have a housing and energy storage devices. The energy storage systems are electrically connected to selected ones of the power generation sources. A system level combiner is in each of the energy storage systems, and the system level combiner combines power from the energy storage devices and selected ones of the power generation sources to provide system level combined power as a first output. A reservoir level combiner combines the system level combined power from a plurality of system level combiners into a reservoir level combined power. A power conditioning system receives, combines, and conditions the reservoir level combined power from the energy storage systems for supply to a power network. The energy storage devices are electrically connected to each other through the system level combiner and the reservoir level combiner.

### CROSS-REFERENCE TO RELATED APPLICATIONS

This application claims the benefit of U.S. Provisional Application No. 62/566,413 filed Sep. 30, 2017.

### BACKGROUND OF THE INVENTION

The subject matter disclosed herein relates generally to integration of power generation sources and energy storage systems.

The worldwide demand for electrical energy has been increasing year by year. Much of the electrical energy demand is met by energy produced from conventional energy sources such as coal and gas. However, in recent years, there has been a push for electricity generation by renewable energy resources such as solar power and wind power.

Wind turbine generators are regarded as environmentally friendly and relatively inexpensive alternative sources of energy that utilize wind energy to produce electrical power. Further, solar power generation uses photovoltaic (PV) modules to generate electricity from sunlight. Since the intensity of wind and sunlight is not constant, the power output of wind turbines and PV modules fluctuate throughout the day. Unfortunately, electricity demand does not vary in accordance with solar and wind variations.

An energy storage system may help to address the issue of variability of solar and wind power to some extent. Essentially, the variable power from solar and wind power plants can be stored in the energy storage system which can then be used at a later time or at a remote location. Energy storage systems may also be charged from a power network and could be used to address frequency variations, harmonic suppression, voltage support, and power quality in the power network.

Certain conventional solar power generation systems such as described in commonly assigned Sok U.S. Pat. No. 8,217,534 combine arrays of solar modules using a plurality of first level solar combiners and then combine the power from the first level solar combiners at a second level solar combiner before conditioning the fully combined power for use by a power network. This is done in part because otherwise it would not be practical to have a high number of wires from individual solar arrays entering a single solar combiner. Typically, when energy storage is used to supplement such conventional solar power generation systems, the storage is situated at a common location such as near the second level solar combiner.

### BRIEF DESCRIPTION OF THE INVENTION

By using a plurality of energy storage systems to combine power output from renewable power generation sources with energy storage devices in the respective energy storage systems, the need for separate first level combiner systems is eliminated and a smaller volume of wires and fuses may be used as compared to those required in conventional approaches.

A reservoir includes power generation sources and energy storage systems. At least some of the energy storage systems have a housing and energy storage devices. The energy storage systems are electrically connected to selected ones of the power generation sources. A system level combiner is in each of the energy storage systems, and the system level combiner combines power from the energy storage devices and selected ones of the power generation sources to provide system level combined power as a first output. A reservoir level combiner combines the system level combined power from a plurality of system level combiners into a reservoir level combined power. A power conditioning system receives, combines, and conditions the reservoir level combined power from the energy storage systems for supply to a power network. The energy storage devices are electrically connected through the system level combiner and the reservoir level combiner.

An energy storage system has a housing, a plurality of energy storage devices, and connections for receiving power from selected ones of a plurality of power generation sources. A system level combiner combines the power from the respective energy storage devices and selected ones of the power generation sources to provide system level combined power as an output. A reservoir level combiner combines the system level combined power from a plurality of system level combiners into a reservoir level combined power. The energy storage devices are electrically connected through the system level combiner and the reservoir level combiner so that a two-way power transfer path is created between the energy storage devices and each respective system level combiner via the reservoir level combiner.

A reservoir system includes a plurality of power generation sources and a plurality of energy storage systems. At least some of the energy storage systems include one or more energy storage devices, and the energy storage systems are electrically connected to selected ones of the power generation sources. A system level combiner is in each of the energy storage systems. The system level combiner combines power from the energy storage devices and selected ones of the power generation sources to provide system level combined power as a first output. A reservoir level combiner combines the system level combined power from a plurality of system level combiners into a reservoir level combined power. A power conditioning system receives, combines, and conditions the reservoir level combined power for supply to a power network. The energy storage devices are electrically connected through the system level combiner and the reservoir level combiner so that a two-way power transfer path is created between the energy storage devices and each respective system level combiner via the reservoir level combiner.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a conventional system.

FIG. 2 is a block diagram of a system in accordance with one embodiment disclosed herein.

FIG. 3 is a block diagram of a system in accordance with another embodiment disclosed herein.

FIGS. 4-5 are perspective and diagram views of a portion of system in accordance with another embodiment disclosed herein.

### DETAILED DESCRIPTION OF THE INVENTION

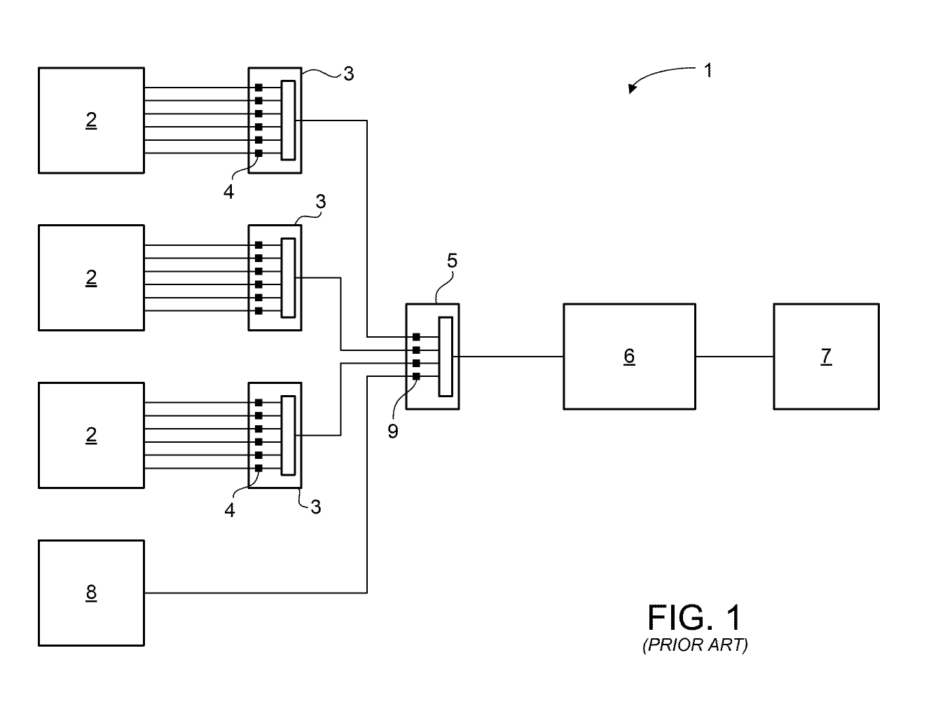

FIG. 1 is a block diagram of a conventional system 1. Power from groups of power generation sources 2 is combined at first level power combiners 3 which then feed power to a main combiner 5 in parallel with power being fed from an energy storage source 8. This power is then provided to a power conditioning system 6 before being supplied to a power network 7. Additionally, fuses 4 and 9 are present in the combiners 3, 5. Although one energy storage source 8 is shown for purposes of example, typically multiple energy storage sources are combined at main combiner 5, each having a separate connection and fuse 9.

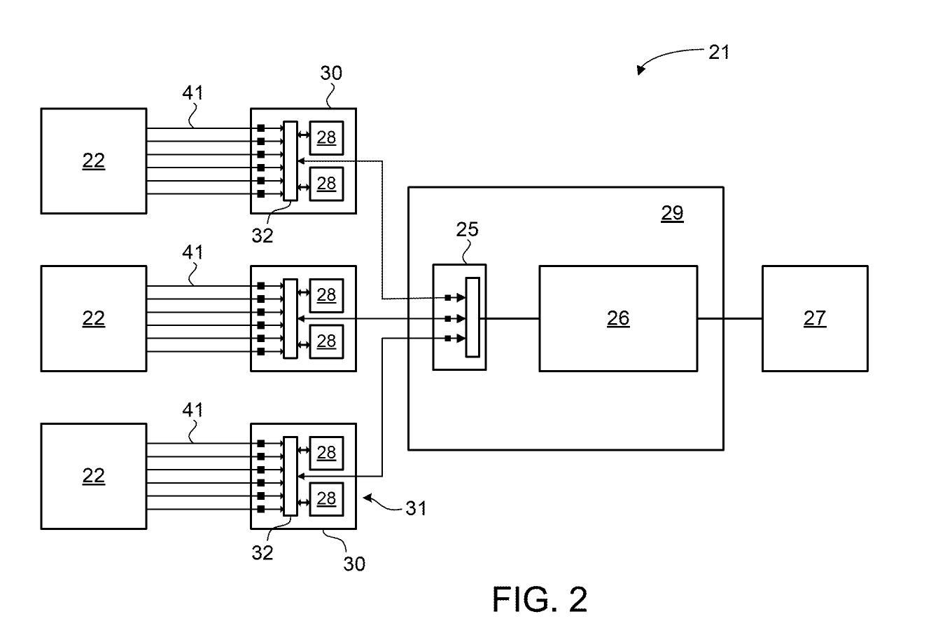

FIG. 2 is a block diagram in accordance with one embodiment disclosed herein wherein a reservoir (or reservoir system) 21 comprises power generation sources 22, energy storage systems 30, and a power conditioning system 29 for receiving, combining, and conditioning combined power from the energy storage systems for supply to a power network 27. As compared with the embodiment of FIG. 1, the energy storage integration with the power generation sources results in a decrease in the amount of wires and fuses.

Power generation sources 22 may comprise renewable power generation sources such as solar power panels, wind turbines, or hydro power turbines, for example, or more conventional sources such as gas or diesel engines. Power network 27 may comprise one or more of a utility grid, a microgrid, and a load, for example.

Energy storage systems 30 may include any number and type of energy storage devices 28 with several examples including batteries such as lithium batteries, sodium halide batteries, molten salt batteries, and flow batteries. Although two energy storage devices 28 are shown per energy storage system 30 for purposes of a simple example, typically a larger number of energy storage devices will be present in each energy storage system 30. In one example (not shown in FIG. 2), multiple battery strings each include multiple battery modules coupled to a string level power converter, and each of the battery modules includes series and or parallel coupled battery cells.

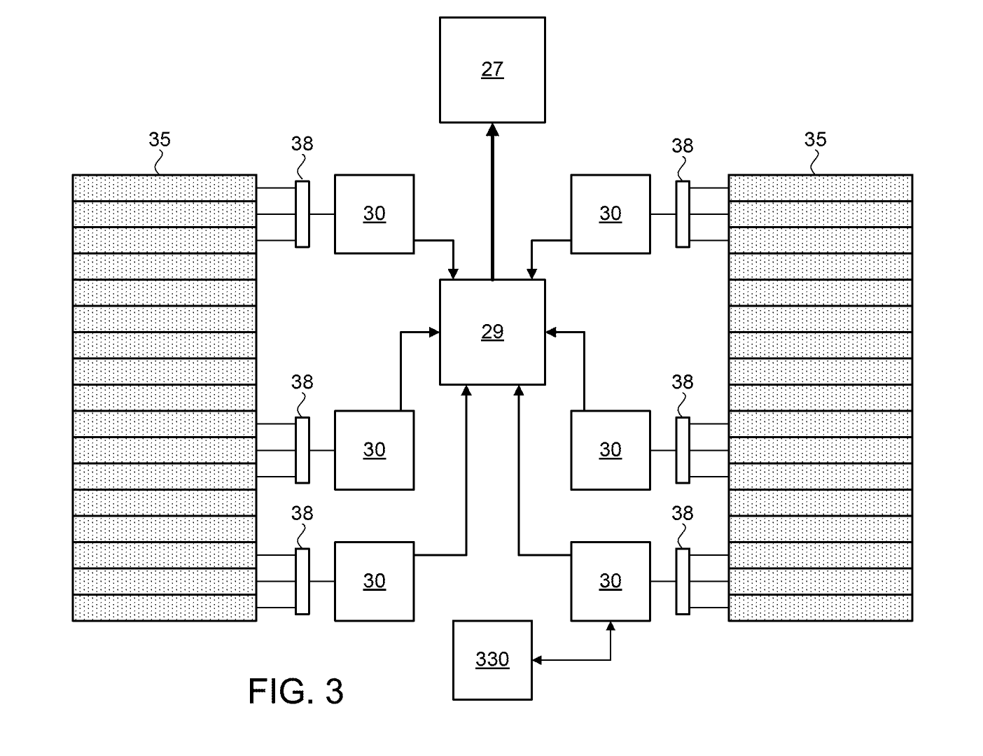

The energy storage systems 30 in FIG. 2 further comprise a housing 31, electrical connections 41 for receiving power from selected ones of the plurality of power generation sources 22, and a system level combiner 32 for combining the power from the respective energy storage devices 28 and selected ones of the plurality of power generation sources 22 to provide system level combined power as an output from system level combiner 32. In some embodiments (not shown), if desired, additional power generation sources may be at the site and coupled directly to the power conditioning system 29. Furthermore, in some embodiments, if desired, additional energy storage systems may be at the site and coupled directly to the power conditioning system 29 (not shown) or to one of the energy storage systems 30 of the type shown in FIG. 2 (as shown in FIG. 3, for example).

Power conditioning system 29 typically comprises a reservoir level combiner 25 and a converter 26. The type of reservoir level combiner and converter will depend upon the specific application. For example, in embodiments wherein solar power generation sources supply power to a network 27 that is an AC utility grid, DC power is generated by power generation sources 22 and may be combined with the DC power from energy storage devices 28 at system level combiners 32 which is then sent as DC power to reservoir level combiner 25 before being supplied to converter 26 that comprises a DC/AC converter. In another example wherein wind turbines are used, power generation sources 22 comprise wind turbines. When such wind turbines or the energy storage systems include AC/DC converters (not shown) to convert the AC power from the wind turbine to DC power, the DC and AC combining and conversion may be similar to the solar embodiment. If such wind turbines or energy storage systems do not include AC/DC converters for the wind power, then the coupling may vary. For example, DC/AC converters may be used in the energy storage systems 30 so that the power from the energy storage devices may be converted into AC power for coupling with the AC power from the wind turbines, and converter 26 may comprise and AC/AC. As another example, if network 27 includes DC transmission, then converter 26 is designed to provide DC power.

The reservoir level combiner 25 and system level combiners 32 also function as a two-way electrical connection path between the plurality of the energy storage devices 28 and the power generation sources 22. The advantage of this configuration is that one power generation source 22 can be used to supply power to multiple and remotely located energy storage devices 28. For example, if the bottom left power generation source 22 in FIG. 2 was the only power generation source actively generating power, then this power could be used to charge the energy storage devices 28 in all the energy storage systems 30, as excess power would be routed through reservoir level combiner 25 to the top two system level combiners 32 and then to their respectively connected energy storage devices 28. All of the energy storage devices 28 are interconnected through the system level combiners 32 and reservoir level combiner 25, and all the energy storage devices 28 may be charged by any or all of the power generating sources 22.

FIG. 3 is a block diagram of another embodiment disclosed herein wherein the power generation sources comprise solar power arrays 35. FIG. 3 further illustrates the distributed locations of the energy storage systems 30 and optionally the power conditioning system 29 with respect to parallel arrays of a solar field. More specifically, in the embodiment of FIG. 3, at least one of the energy storage systems 30 is situated between at least two of the solar power arrays. For ease of illustration only some of the connections between the arrays 35 and energy storage system 30 are shown. Open land may already be available on the field for reasons such as power line or roadway access and result in a reservoir with a smaller footprint need as compared with reservoirs having all the energy storage in a central location. FIG. 3 further illustrates the optional use of solar (PV) spot optimizer units 38 between several solar arrays 35 and an energy storage system 30. Commercially available PV spot optimizers typically comprise 4 DC/DC converters hooked to 4 arrays to create a stiff voltage. If stiffer voltages are input into the energy storage systems 30, stiffer voltages from the energy storage systems will result and in turn permit a higher voltage rating on power conditioning system 29.

FIG. 3 further illustrates an additional standalone energy storage system 330 which is coupled to energy storage system 30 in addition to photovoltaic arrays 35. Such an embodiment may be useful if more energy storage is needed over time and/or if energy storage in initial energy storage systems 30 degrades over time. It may be useful to identify one of the energy storage systems 30 when installing at the site so that such an energy storage system 30 may have a larger DC bus and connections to accommodate the addition of power from additional energy storage system 330.

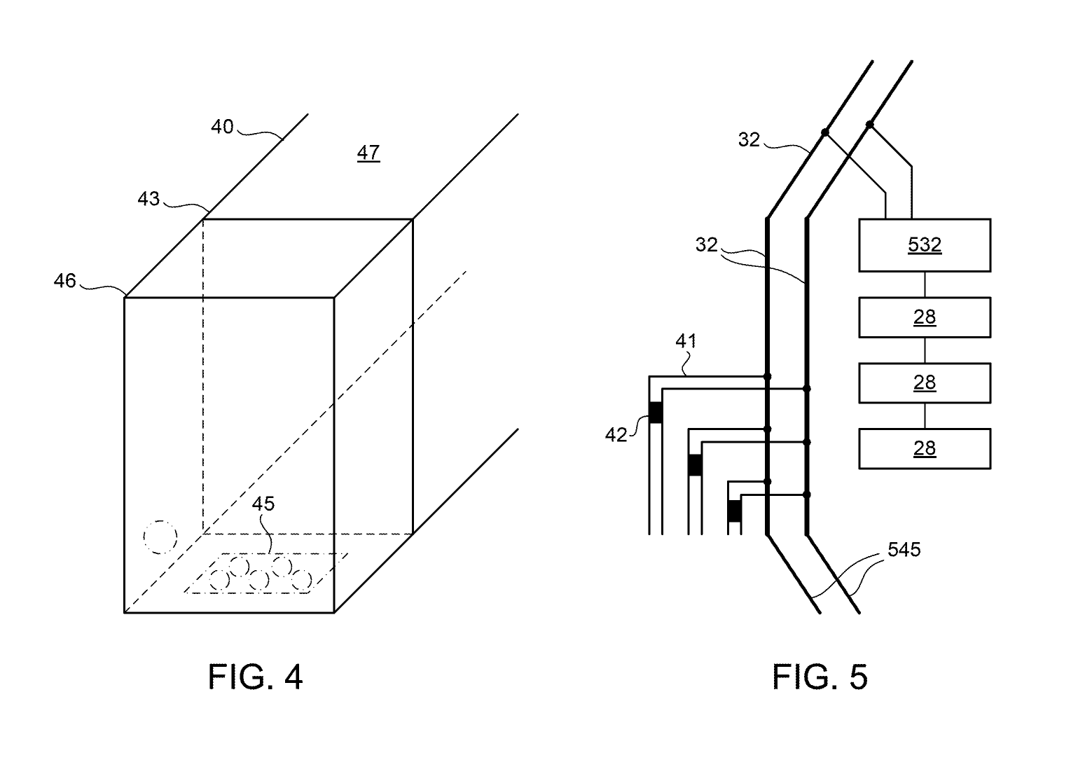

FIGS. 4 and 5 are a perspective views of portions of an energy storage system 40 in accordance with another embodiment disclosed herein. The connections 41 may be used to receive the power from the solar arrays shown in FIGS. 2-3 and are coupled to bus bars or system level combiners 32 which, when leaving energy storage system 30, must be thick enough to support the combined power of the coupled solar arrays and the housed energy storage devices 28 (such as batteries) and thus are typically thicker than either a single solar array wire or an energy storage wire that is coupled to a bus bar.

In the example of FIGS. 4 and 5 housing 43 encases a main region 47 and an end region 46 having access areas 45 in the sides or bottom, for example. In one embodiment, the end regions 46 are modular such that the nature of the access areas and/or the thickness of the bus bars may vary depending upon specific intended uses. In the specific embodiment of FIGS. 4-5, the DC bus bars 32 exit the energy storage system 40 through the bottom and the power connections from the power generation sources feed into the bottom of the end region and are coupled by connections 41 and fuses 42 to the DC bus bars 32. If desired, other protection devices (not shown) such as circuit breakers and diodes may be included in end portion 46. Furthermore, controllers and auxiliary components such as HVAC equipment (not shown) may be housed in end portion 46.

In addition to the system level combiner 32 including the bus bars in end region 46 of FIGS. 4-5, FIGS. 4-5 additionally show an embodiment wherein energy storage devices 28 are arranged in a string and coupled to a DC/DC converter 532 which is in turn coupled to the DC bus bars 45 through DC bus bars 32 which may optionally have smaller diameters than those of other DC bus bars as less power is present in that portion of the energy storage system.

When some combining of power generation source power and battery power occurs at each energy storage system, a smaller main combiner (FIG. 2) may be used as the inputs to the main combiner are partially pre-combined.

In addition to cost savings due to elimination of power generation source specific combiner systems and reduction in amount of wire and fuse requirements, another advantage of using the energy storage system for combiner purposes relates to sensing and control. Energy storage systems typically have a number of sensors and using those same sensors or adding several more for power generation source related measurements is useful for providing a simpler communication path to share information about the status of the system as a whole.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

1. A reservoir comprising:
power generation sources;
energy storage systems, at least some of the energy storage systems comprising a housing and energy storage devices, the energy storage systems electrically connected to selected ones of the power generation sources;
a system level combiner in each of the energy storage systems, the system level combiner combining power from the energy storage devices and selected ones of the power generation sources to provide system level combined power as a first output;
a reservoir level combiner for combining the system level combined power from a plurality of system level combiners into a reservoir level combined power;
a power conditioning system for receiving, combining, and conditioning the reservoir level combined power from the energy storage systems for supply to a power network; and
wherein the energy storage devices are electrically connected through the system level combiner and the reservoir level combiner.

2. The reservoir of claim 1 wherein the power network comprises a utility grid.

3. The reservoir of claim 2 wherein the power generation sources comprise DC power generation sources, the energy storage devices comprise batteries for providing battery DC power, and the system level combined power comprises system level combined DC power.

4. The reservoir of claim 3 wherein the power conditioning system comprises:
a DC/AC inverter for converting the reservoir level combined power into AC power.

5. The reservoir of claim 3 wherein the DC power generation sources comprise solar power arrays and at least one of the energy storage systems is situated between at least two of the solar power arrays.

6. The reservoir of claim 1 wherein the power network comprises a load.

7. The reservoir of claim 1 wherein an end portion of at least one of the energy storage systems includes at least a portion of the system level combiner, and the system level combiner comprises a DC bus bar.

8. The reservoir of claim 7 wherein the system level combiner further comprises a DC/DC converter coupling the energy storage devices to the DC bus bar.

9. The reservoir of claim 1 further comprising an additional, standalone energy storage system for providing power through one of the energy storage systems.

10. An energy storage system comprising:
a housing;
a plurality of energy storage devices;
connections for receiving power from selected ones of a plurality of power generation sources;
a system level combiner for combining the power from the respective energy storage devices and selected ones of the power generation sources to provide system level combined power as an output;
a reservoir level combiner for combining the system level combined power from a plurality of system level combiners into a reservoir level combined power; and
wherein the energy storage devices are electrically connected through the system level combiner and the reservoir level combiner so that a two-way power transfer path is created between the energy storage devices and each respective system level combiner via the reservoir level combiner.

11. The energy storage system of claim 10 wherein the connections are configured for receiving generated DC power, wherein the energy storage devices comprise batteries for providing battery DC power, and wherein the system level combined power comprises system level combined DC power.

12. The energy storage system of claim 11 wherein an end portion of at least one of the energy storage systems includes the connections and at least a portion of the system level combiner comprising a DC bus bar.

13. The reservoir of claim 12 wherein the system level combiner further comprises a DC/DC converter coupling the energy storage devices to the DC bus bar.

14. A reservoir system comprising:
a plurality of power generation sources;
a plurality of energy storage systems, at least some of the energy storage systems comprising one or more energy storage devices, the energy storage systems electrically connected to selected ones of the power generation sources;
a system level combiner in each of the energy storage systems, the system level combiner combining power from the energy storage devices and selected ones of the power generation sources to provide system level combined power as a first output;
a reservoir level combiner for combining the system level combined power from a plurality of system level combiners into a reservoir level combined power;
a power conditioning system for receiving, combining, and conditioning the reservoir level combined power for supply to a power network; and
wherein the energy storage devices are electrically connected through the system level combiner and the reservoir level combiner so that a two-way power transfer path is created between the energy storage devices and each respective system level combiner via the reservoir level combiner.

15. The reservoir system of claim 14 wherein the power network comprises a utility grid, and the power generation sources comprise DC power generation sources, the energy storage devices comprise batteries for providing battery DC power, and the system level combined power comprises system level combined DC power.

16. The reservoir system of claim 15 wherein the power conditioning system comprises:
a DC/AC inverter for converting the reservoir level combined power into AC power.

17. The reservoir system of claim 16 wherein the DC power generation sources comprise solar power arrays and at least one of the energy storage systems is situated between at least two of the solar power arrays.

18. The reservoir system of claim 17 wherein an end portion of at least one of the energy storage systems includes at least a portion of the system level combiner, and the system level combiner comprises a DC bus bar.

19. The reservoir system of claim 17 wherein the system level combiner further comprises a DC/DC converter coupling the energy storage devices to the DC bus bar.

20. The reservoir system of claim 17 further comprising an additional, standalone energy storage system for providing power through one of the energy storage systems.
